(19) United States
(12) Patent Application Publication
(10) Pub. No.: US 2025/0288963 A1
(43) Pub. Date: Sep. 18, 2025

(54) Dilution Wall

(71) Applicant: Ecochem Australia Pty Ltd, Upper Plenty (AU)

(72) Inventor: Geoffrey Grant Literski, Upper Plenty (AU)

(21) Appl. No.: 18/608,063

(22) Filed: Mar. 18, 2024

(51) Int. Cl. B01F 23/40; B01F 101/24

(52) U.S. Cl. CPC B01F 23/483; B01F 23/49; B01F 2101/24

(57) ABSTRACT

A cleaning solution dilution system is provided for a paperboard converting plant. The system includes a panel that is provided with at least one of: a transport aid to move the system into a paper board converting plant, a mounting aid to hang the system on a wall of the paper board converting plant, or an installation aid having instructions printed directly on the panel. The system also includes at least two mixing apparatus, wherein each of the mixing apparatus includes an inlet for a cleaning solution, an inlet for other fluid, and an outlet for a mixture of the cleaning solution and other fluid. The system includes a plurality of isolation valves, a plurality of one-way valves, and a pressure-limiting valve. If provided, the instructions on the panel direct a user where to assemble the other components.

### TECHNICAL FIELD

This application relates to paperboard converting plants. More particularly, aspects of this application relate to systems for mixing and diluting cleaning chemicals to be used in paperboard converting plants.

### BACKGROUND

In the operation of a paperboard converting plant, tens of thousands of feet of paperboard move through converting equipment on a daily basis. As the paperboard touches feed rollers within the converting equipment, starch rubs from the paperboard onto the feed rollers. Also, as the anilox rolls apply ink to the paperboard, traces of ink remain on the anilox rolls. The residues of ink and starch can detract from efficient operation by smearing or by causing slippage. Accordingly, it is desirable to clean the rollers from time to time.

Rollers can be cleaned by spraying them with soap or other cleaning chemicals. Typically, soap is delivered to a paperboard converting plant in totes of concentrated soap. The concentrated soap then is diluted to its working strength. Often, dilution is a manual operation that involves galoshes, other personal protective equipment, and a hand-held hose.

### SUMMARY

This application discloses a cleaning solution dilution system for a paperboard converting plant. The system includes a panel that is provided with at least one of: a transport aid to move the system into a paper board converting plant, a mounting aid to hang the system on a wall of the paper board converting plant, or an installation aid having instructions printed directly on the panel. The system also includes at least two mixing apparatus, wherein each of the mixing apparatus includes an inlet for a cleaning solution, an inlet for other fluid, and an outlet for a mixture of the cleaning solution and other fluid. The system includes a plurality of isolation valves, a plurality of one-way valves, and a pressure-limiting valve.

### BRIEF DESCRIPTION OF THE DRAWINGS

FIG. 1 depicts an example of a heated cleaning solution dilution system 100, according to an aspect of the disclosure.

FIG. 2 depicts an example of an unheated cleaning solution dilution system 200, according to an aspect of the disclosure.

FIG. 3 depicts a cleaning solution dilution system 200 that is installed in a paperboard converting plant 300, according to an aspect of the disclosure.

FIG. 4 depicts a schematic of a paperboard converting plant 400 that incorporates a cleaning solution dilution system 100, according to an aspect of the disclosure.

FIG. 5 depicts an example of a cleaning solution mixer apparatus 102, according to an aspect of the disclosure.

### DETAILED DESCRIPTION

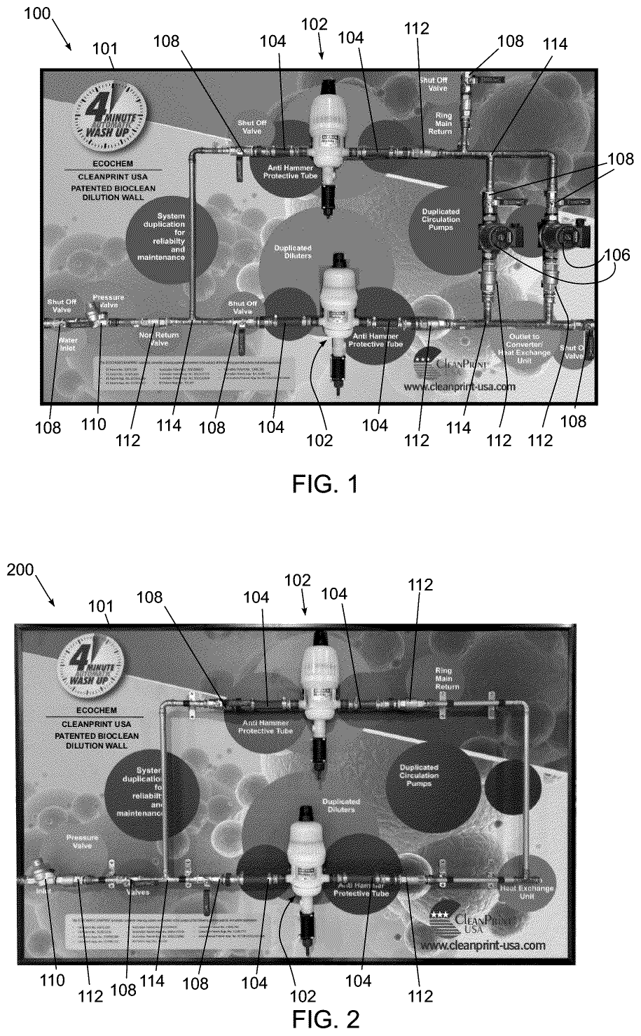

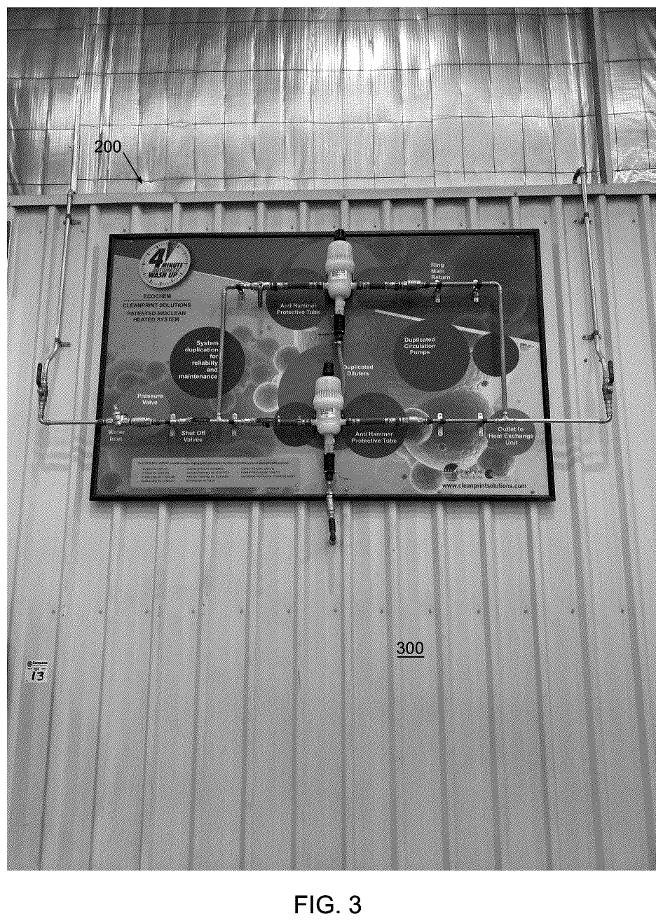

FIG. 1 depicts an example of a heated cleaning solution dilution system 100, according to an aspect of the disclosure. The system 100 is mounted on a printed placard or panel 101, which provides labels that direct where the other components are to be assembled. Among various modes of delivering the system 100 to a user, some options include:
a. delivering the system 100 fully assembled on a roller stand (transport aid, not shown);
b. delivering the system 100 fully assembled with brackets to mount the placard to a wall of a paperboard converting plant, as shown in FIG. 3; or c. delivering the system 100 as one or more boxes of components with the printed placard as an installation aid for the user to assemble the components onto the panel.

The system 100 also includes first and second cleaning solution mixer apparatus 102, which are connected to the rest of the system by anti-hammer flexible hoses 104. Because heating the cleaning solution requires pushing the cleaning solution through heat exchangers, which present flow resistance, the system 100 also includes first and second circulation pumps 106 for that purpose.

Duplicated (“first and second”) components are a theme of the system 100 (and of the system 200, further described below with reference to FIG. 2). Duplicated components make it possible to keep the system in operation while repairing or replacing a worn or damaged component. Shut off valves 108 also enable isolating a component in one part of the system for repair or replacement while maintaining flow through another part of the system.

The system 100 may receive water at any range of pressures, although a minimum pressure of about 40 psi is preferred. To regulate the pressure of water in the system, a pressure valve 110 is provided at the water inlet. In some embodiments, the pressure valve 110 regulates the water supply to about 40 psi.

Because it is preferable to prevent cleaning solution backflowing into the water supply, a non-return valve 112 is provided immediately downstream from the pressure valve. Similar non-return valves 112 also are provided downstream from the circulation pumps 106.

T-joints 114 provide for parallel duplicate flow paths so that a portion of the system may be isolated for service while maintaining operation of the overall system.

As can be seen from FIG. 1, the panel or placard 101 is marked with labels that instruct a user where to attach the other components of the system 100.

FIG. 2 depicts an example of an unheated cleaning solution dilution system 200, according to an aspect of the disclosure. Because the unheated system 200 does not require pushing diluted solution through heat exchangers, the circulation pumps 106 and their non-return valves 112 may be omitted from the unheated system.

FIG. 3 depicts an example of an unheated cleaning solution dilution system 200 that is installed in a paperboard converting plant 300, according to an aspect of the disclosure. By providing the entire system on a single panel 101, the system can readily be installed (e.g., attached to a wall of the plant) for use.

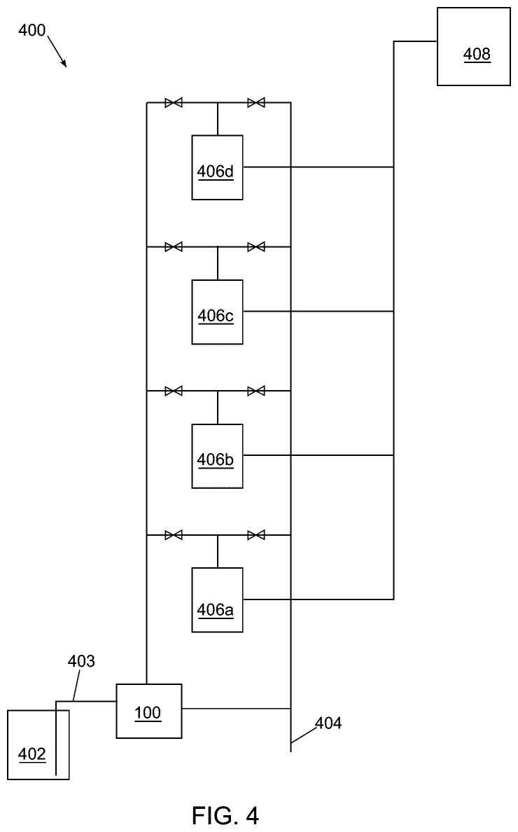

FIG. 4 depicts a schematic of a paperboard converting plant 400 that incorporates a cleaning solution dilution system 100, according to an aspect of the disclosure. The system 100 receives pressurized water from a supply line 404, and its mixer apparatus 102 use the pressurized water to suck in and dilute cleaning solution from a tote or other reservoir 402 via a suction line or hose 403. The system 100 then delivers the diluted cleaning solution to one or more of the paperboard converters 406a, 406b, 406c, 406d. From the converters, waste cleaning solution goes to a sump 408. The general arrangement of a paperboard converting plant will be familiar to a skilled worker.

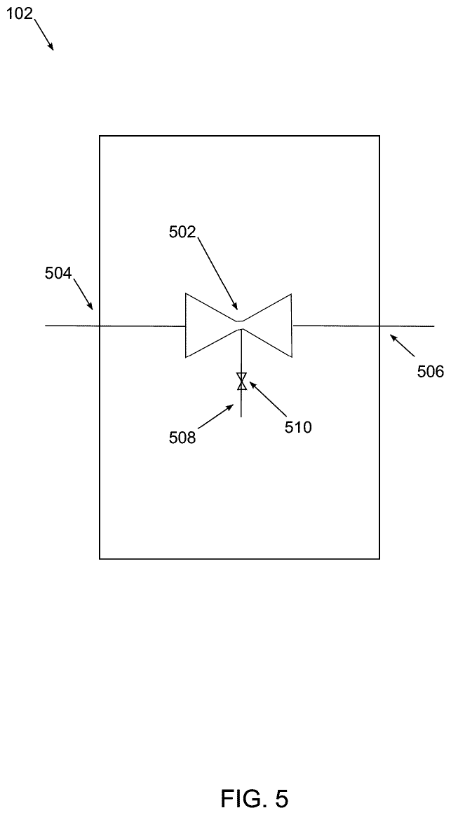

FIG. 5 depicts an example of a cleaning solution mixer apparatus 102, according to an aspect of the disclosure. The apparatus 102 includes a venturi nozzle 502. The venturi nozzle 502 receives pressurized water from a water inlet 504, sucks in cleaning solution from a cleaning solution inlet 508 through a proportioning valve 510, and discharges the mixture of diluted cleaning solution to an outlet 506. The proportioning valve 510 can be throttled to adjust the fraction of cleaning solution that is mixed with the water.

What is claimed is:

1. A cleaning solution dilution system for a paperboard converting plant, the system comprising:
a panel that is provided with at least one of: a transport aid to move the system into a paper board converting plant, a mounting aid to hang the system on a wall of the paper board converting plant, or an installation aid having instructions printed directly on the panel;
at least two mixing apparatus, wherein each of the mixing apparatus includes an inlet for a cleaning solution, an inlet for other fluid, and an outlet for a mixture of the cleaning solution and other fluid;
a plurality of isolation valves;
a plurality of one-way valves;
a pressure-limiting valve.

2. The system of claim 1, further comprising a plurality of anti-hammer hoses.

3. The system of claim 1, wherein at least one of the mixing apparatus also includes a proportioning structure for adjusting a ratio of the cleaning solution to the other fluid in the mixture.

4. The system of claim 1, wherein at least one of the mixing apparatus also includes a venturi nozzle for establishing suction at its cleaning solution inlet in response to a flow of other fluid from its other fluid inlet to its outlet.

5. The system of claim 1, further comprising at least one circulation pump.

6. The system of claim 1, wherein the instructions direct an installer to assemble components of the system to provide parallel duplicate flow paths through a plurality of parallel mixing apparatus.

7. A paperboard converter cleaning solution dilution apparatus comprising:
a kit that is provided with at least one of: a transport aid to move the kit into a paper board converting plant, a mounting aid to hang the kit on a wall of the paper board converting plant, or an installation aid having instructions printed directly on the kit;
at least two mixing apparatus, wherein each of the mixing apparatus includes an inlet for a cleaning solution, an inlet for other fluid, and an outlet for a mixture of the cleaning solution and other fluid;
a pressure-limiting valve;
a first one-way valve that is connected in fluid communication downstream from the pressure-limiting valve;
a first tee connection that is connected in fluid communication downstream from the first one-way valve;
a first anti-hammer hose that is connected in fluid communication downstream from a first branch of the first tee connection, the first anti-hammer hose being connected in fluid communication to the other fluid inlet of one of the mixing apparatus; and
a second anti-hammer hose that is connected in fluid communication downstream from a second branch of the first tee connection, the second anti-hammer hose being connected in fluid communication to the other fluid inlet of another of the mixing apparatus.

8. The apparatus of claim 7, further comprising a first isolation valve that is connected in fluid communication between the pressure-limiting valve and the first tee connection.

9. The apparatus of claim 7, further comprising a hose that is connected in fluid communication from a container of cleaning solution to the cleaning solution inlet of one of the mixing apparatus.

10. The apparatus of claim 9, further comprising the container of cleaning solution.

11. The apparatus of claim 7, wherein at least one of the mixing apparatus also includes a venturi nozzle for establishing suction at its cleaning solution inlet in response to a flow of other fluid from its other fluid inlet to its outlet.

12. The apparatus of claim 7, wherein at least one of the mixing apparatus also includes a proportioning structure for adjusting a ratio of the cleaning solution to the other fluid in the mixture.

13. The apparatus of claim 7, further comprising at least one circulation pump.

14. A converter roll cleaning system that is installed in a paper board converting plant, the system comprising:
a plurality of mixing apparatus for cleaning solution, which are connected in parallel fluid communication, wherein each of the mixing apparatus includes an inlet for a cleaning solution, an inlet for other fluid, and an outlet for a mixture of the cleaning solution and other fluid;
a hose that is connected in fluid communication with the cleaning solution inlet of at least one of the mixing apparatus; and
a container of cleaning solution, with which the hose is in fluid communication.

15. The system of claim 14, wherein the plurality of mixing apparatus are affixed to a panel that is affixed to a wall of the converting plant.

16. The system of claim 15, wherein the panel comprises a printed surface with markings that identify assembly locations for other components of the system.

17. The system of claim 14, further comprising a plurality of anti-hammer hoses that connect the plurality of mixing apparatus in fluid communication with a plurality of paper board converters.

18. The system of claim 14, further comprising at least one circulation pump.

19. The system of claim 14, wherein at least one of the mixing apparatus includes a venturi nozzle for establishing suction at its cleaning solution inlet in response to a flow of other fluid from its other fluid inlet to its outlet.

20. The system of claim 14, further comprising a wastewater sump.
